(19) United States
(12) Patent Application Publication
(10) Pub. No.: US 2005/0118390 A1
(43) Pub. Date: Jun. 2, 2005

(54) Continuous strand mats, methods of producing continuous strand mats, and systems for producing continuous strand mats

(76) Inventors: Thomas C. Wagner, Pittsburgh, PA (US); Peter L. DeWalt, Charlotte, NC (US)

Correspondence Address: J. Jason Link;Kilpatrick Stockton LLP, 1001 West Fourth Street, Winston-Salem, NC, 27101, US

(21) Appl. No.: 10/920,870

(22) Filed: Aug. 18, 2004

Related U.S. Application Data
(60) Provisional application No. 60/496,200, filed on Aug. 19, 2003.

(51) Int. Cl. B32B 3/06

(52) U.S. Cl. 428/102

(57) ABSTRACT

The present invention relates to continuous strand mats, methods of producing continuous strand mats, and systems for producing continuous strand mats. A continuous strand mat can comprise a layer comprising a plurality of randomly oriented continuous strands of glass fibers and a plurality of stitches through the layer comprising at least one stitch yarn, wherein the stitches secure at least a portion of the plurality of strands to form the mat. A method of producing a continuous strand mat can comprise forming a loose mat of continuous strands of fiber glass and stitch bonding the loose mat.

### CROSS REFERENCE TO RELATED APPLICATION

This application claims priority to, and incorporates by reference in full, the following co-pending application: U.S. Provisional Patent Application No. 60/496,200, filed Aug. 19, 2003, entitled “Stitch-Bonding of Continuous Strand Fiber Glass Mats.”

### FIELD OF THE INVENTION

The present invention relates generally to continuous strand mats, methods for producing continuous strand mats, and systems for producing continuous strand mats.

### BACKGROUND OF THE INVENTION

Glass fibers and glass fiber strands have been used before in the art to produce various types of glass fiber mats for use as reinforcement material. The basic principles of mat-making are well known in the art and are fully described in K. Lowenstein, The Manufacturing Technology of Continuous Glass Fibres, (3d Ed. 1993), at pages 293-312. Typical processes for making mats of continuous fiber glass strands are also described in U.S. Pat. No. 3,883,333 (Ackley), and U.S. Pat. No. 4,158,557 (Drummond).

A particular utility for glass fiber mats is in the reinforcement of resinous or polymeric materials since the presence of an integrally molded glass fiber mat substantially increases the strength of these materials. Glass fiber mats can be used, for example, in pultrusion, resin infusion molding, resin transfer molding, compression molding, SCRIMP, and open molding of composite parts. Usually, the mat and a molten resin are processed together to form a thermoset or thermoplastic composite. Thermoset composites are particularly attractive for use in the aircraft, marine, and land transportation industries, as well as in construction, corrosion-resistance, and electrical applications.

Continuous strand mats have application in a number of processes utilizing thermoset resins, including, for example, pultrusion, resin infusion molding, resin transfer molding, compression molding, vacuum assist resin transfer molding, and open molding of composite parts. Pultrusion processes, for example, may be used to form I-beams, tool handles, ladder rails, tree limb cutter extensions, and other products. A fiber glass manufacturer may supply rolls of continuous strand mats to a composite manufacturer. The width of the rolls may vary depending on the composite manufacturers' needs and/or the fiber glass manufacturers' equipment. The rolls may be slit by the composite manufacturer to a smaller width depending on the end product. The continuous strand mat is saturated with a resin and pulled through a shaped die at a temperature sufficient to set the shape of the composite.

It can be important in such applications for the continuous strand mats used to make these laminates to have as uniform a fiber density distribution as possible. If a non-uniform density mat is used for reinforcement purposes, the products produced therefrom may have a substantial variation in their strength since some areas may be weaker due to the lack of glass fiber reinforcement while others may be stronger.

In the production of continuous strand mats, a plurality of strand feeders are positioned above a moving belt or conveyor, typically a continuously driven, flexible, stainless steel chain or other perforated surface. In the operation of one type of lay down machine, the strand feeders are reciprocated or traversed back and forth above the conveyor parallel to one another and usually in a direction generally perpendicular to the direction of motion of the moving conveyor. Strands composed of multiple glass fiber filaments are fed to the feeders from a suitable supply source such as a plurality of previously made forming packages.

It is well known in the art that the feeder can act as an attenuator to attenuate glass fibers directly from a glass fiber-forming bushing and eventually deposit strand formed therefrom directly onto the conveyor as described by Lowenstein, supra, at pages 248 to 251 and further illustrated in U.S. Pat. No. 3,883,333 (Ackley), U.S. Pat. No. 4,158,557 (Drummond), U.S. Pat. No. 4,963,176 (Bailey, et al.), and U.S. Pat. No. 4,964,891 (Schaefer).

Each feeder apparatus provides the pulling force necessary to advance the strand from the supply source and eventually deposit it upon the surface of the moving conveyor. In a typical production environment, a plurality of such strand feeders have been used simultaneously with one another to produce a glass fiber mat. Notable references describing the operation and control of such reciprocating feeders can be found in U.S. Pat. No. 3,915,681 (Ackley) and U.S. Pat. No. 4,340,406 (Neubauer, et al.) as well as U.S. Pat. No. 4,963,176 (Bailey, et al.) and U.S. Pat. No. 4,964,891 (Schaefer), which are hereby incorporated by reference.

Once the strand has been deposited on the conveyor to form a random pattern of loose glass strand, mechanical integrity must somehow be imparted to it so that these loose strands can be subsequently handled as a mat and eventually fabricated into a finished laminate. For example, if the mat has insufficient tensile strength in the machine direction (the direction parallel to the direction of movement of the mat), the mat could pull apart when it is slit to a smaller width and pulled through a pultrusion process.

One method known in the art to improve mechanical integrity is to pass the loose strands through a needling device wherein a plurality of barbed needles are reciprocated up and down so as to penetrate the strands and thereby entangle them with one another. This technique is further described in U.S. Pat. No. 3,713,962 (Ackley), U.S. Pat. No. 4,277,531 (Picone), U.S. Pat. No. 4,404,717 (Neubauer, et al.), and U.S. Pat. No. 4,964,891 (Schaefer). The needling of mats can cause broken filaments, which may lead to difficulties in downstream processing.

Another method by which the loose strand can be bound into the form of a mat is to impregnate the strand with a chemical resin, typically referred to as a binder, and then melt or heat it so that the individual strands comprising the mat structure become bonded to one another. Binders used to bond the individual strands in the mat structure are often powder binders, although liquid binders can also be used. An example of such a method is described in U.S. Pat. No. 5,051,122 (Reese). Usually, this melting operation takes place inside an oven through which both the conveyor and the strand pass. The oven must be of a sufficient length and heated to such a degree that the residence time of the glass strand and resin inside the oven is long enough to thoroughly melt the resin and dry any excess moisture from the strand. Ovens having a length of 20 feet (6.1 meters) or more are not uncommon. Besides the physical size of the oven, there is also the expense associated with its construction and keeping it in continuous operation.

The use of binders such as low styrene soluble, crosslinked polyesters are particularly well suited to increase the mechanical strength of continuous strand mats. However, the cost of binders also increases the manufacturing costs.

The use of binders, while providing the dry tensile strength in a mat, can also result in the mat becoming too stiff, can often result in discoloration (off-white color) to the mat, and can often result in some loose fibers not being bound to the mat. As an example, increased stiffness can make it more difficult to pull the mat through a die as part of a pultrusion process such that the mat may not fill out the molded product completely. As another example, in resin transfer molding applications, a stiff mat can make it more difficult to conform the mat to the mold. Thus, a balance between increased tensile strength with adequate conformabilty is desired.

Another challenge with the use of binders is insuring that the binder is evenly distributed within the mat. This challenge is of particular concern with the use of powder binders.

It would be desirable to eliminate the use of an oven for melting and/or curing powder binder and/or drying liquid binder impregnated continuous strand fiber glass mats. It would be desirable to produce continuous fiber glass strands having desirable tensile strength, color, softness, conformability, and other properties without the use of binders. It would also be desirable to produce continuous fiber glass strand mats having uniform density and mechanical properties without the use of binders.

### SUMMARY

The present invention relates to continuous strand mats, to methods of producing continuous strand mats, and to systems for producing continuous strand mats.

In some embodiments, continuous strand mats can comprise a layer comprising a plurality of randomly oriented continuous strands of glass fibers and a plurality of stitches through the layer comprising at least one stitch yarn, wherein the stitches secure at least a portion of the plurality of strands to form the mat. The mat, in some embodiments, can be primarily formed by the plurality of stitches securing at least a portion of the plurality of strands. In some embodiments, the mat can be formed without the use of a binder.

In some embodiments, methods of producing continuous strand mats can comprise forming a loose mat of continuous strands of fiber glass and stitch bonding the loose mat. The plurality of continuous strands can be deposited in a random orientation in some embodiments. Stitch bonding the loose mat can comprise stitching a plurality of stitches in the loose mat. Embodiments of methods of the present invention can also comprise needling the loose mat of continuous strands so as to entangle individual glass strands together with one another.

Embodiments of systems for producing continuous strand mats of the present invention can comprise a supply of fiber glass strands, a lay down machine for a randomly oriented continuous strand mat, and a stitch bonding machine. In some embodiments, systems of the present invention can further comprise a needling device.

These and other embodiments of the present invention are described in greater detail in the detailed description of the invention which follows.

### BRIEF SUMMARY OF THE FIGURES

FIG. 1 is a top elevational view of a swatch of an embodiment of a stitch bonded mat of the present invention.

FIG. 2 illustrates an example of a stitching technique that can be used to stitch bond an embodiment of a continuous strand mat of the present invention.

FIG. 3 illustrates a side view of a portion of an apparatus for stitch bonding continuous strand mats of the present invention.

FIG. 4 is a top elevational view illustrating an embodiment of how stitch yarns may be used to stitch bond a continuous strand.

FIG. 5 is a top elevational view illustrating another embodiment of how stitch yarns may be used to stitch bond a continuous strand mat.

### DETAILED DESCRIPTION OF THE INVENTION

For the purposes of this specification, unless otherwise indicated, all numbers expressing quantities of ingredients, reaction conditions, and so forth used in the specification are to be understood as being modified in all instances by the term “about.” Accordingly, unless indicated to the contrary, the numerical parameters set forth in the following specification are approximations that can vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10. Additionally, any reference referred to as being “incorporated herein” is to be understood as being incorporated in its entirety.

It is further noted that, as used in this specification, the singular forms “a,” “an,” and “the” include plural referents unless expressly and unequivocally limited to one referent.

The present invention is generally useful in the manufacture of fiber glass mats. Persons of ordinary skill in the art will recognize that the present invention can be implemented in the production, assembly, and application of a number of glass fibers. Non-limiting examples of glass fibers suitable for use in the present invention can include those prepared from fiberizable glass compositions such as “E-glass”, “A-glass”, “C-glass”, “S-glass”, “ECR-glass” (corrosion resistant glass), and fluorine and/or boron-free derivatives thereof.

The present invention relates to continuous strand mats, to methods of producing continuous strand mats, and to systems for producing continuous strand mats. The continuous strand mats may comprise randomly oriented continuous strands. The term “strand” as used herein means a multiplicity of fibers grouped together. The phrase “continuous strand” as used herein means that the strands generally can have an average length of about 10 meters to about 400 kilometers (km). While it would be desirable to have a supply of strands that do not break, breaks in the strands do occur on occasion, such that it is difficult to supply a literally continuous strand. Thus, while it is desirable to supply as long a strand as possible, the total length of the strands should not be viewed as limiting so long as the mat lay down machine receives a supply of strands that enables it to form a continuous strand mat. In today's commercial manufacturing environment, in embodiments where continuous strand is supplied from a package or a plurality of packages, the continuous strand typically has a length between about 40,000 and about 160,000 meters.

It should be understood that while the continuous strands may have a nominal length within the above ranges, it is possible that some strands within the mat may have lengths outside of the above ranges due to manufacturing and/or processing conditions. For example, packages may be spliced together to form longer continuous strands. As another example, continuous strands may be supplied directly from a forming operation without winding on a package. As another example, a strand from a package may break during lay down. As other examples, some manufacturers may trim the edges of the continuous strand mats, or continuous strand mats may be slit into smaller width mats. When the edges of a mat are trimmed or when a mat is slit into smaller width mats, some of the strands near the edges of the mat may be cut, such that the lengths of the strands in the mat may be shorter than the lengths of the strands when laid down and stitch bonded.

As used herein, the term “randomly oriented” means that the strands are not oriented to one another in a particular, organized manner. For example, with knit products or knit fabrics, rovings may be oriented generally parallel to one another in the machine direction, at a ninety degree angle to the machine direction, at a forty-five degree angle to the machine direction, and/or at other angles to the machine direction.

Embodiments of the present invention can provide randomly oriented, continuous strand mats wherein the mat is primarily formed by the plurality of stitches securing at least a portion of the plurality of strands. As used herein, “primarily formed” refers to the principle way in which the strands are secured or otherwise held in position. If multiple techniques are used that individually or in combination can form a mat, a single technique can primarily form the mat. For example, as noted above, in some embodiments, the mat can be primarily formed by the plurality of stitches securing at least a portion of the plurality of strands. Other techniques could be used in combination with the plurality of stitches, such as the use of a binder or the use of needling, but such other techniques would not be the primary way in which the strands are secured or otherwise held in position in accordance with embodiments of the present invention.

In some embodiments where the mat is primarily formed by the plurality of stitches, the mat may not have enough mechanical integrity to withstand processing in a downstream application (e.g., a pultrusion process) in the absence of such plurality of stitches. The mechanical integrity of a mat can be measured in a number of ways. One measure of mechanical integrity is the dry tensile strength of the mat. Dry tensile strength can be measured using a Model UTSM tensile testing machine from Chatillon (a Chatillon UTSM tensile testing machine).

In some embodiments of the present invention, a mat that does not have enough mechanical integrity to withstand processing in a downstream application will have a dry tensile strength of about sixteen pounds or less. In some non-limiting embodiments, a mat that is primarily formed by the plurality of stitches securing at least a portion of a plurality of strands that has a density of about one ounce per square foot can have a dry tensile strength of about forty-four pounds or greater. In some non-limiting embodiments, a mat that is primarily formed by the plurality of stitches securing at least a portion of a plurality of strands that has a density of about 0.75 ounces per square foot can have a dry tensile strength of about sixteen pounds or greater. The above dry tensile strengths refer to dry tensile strengths of three inch wide by nine inch long mat samples measured using a Chatillon UTSM tensile testing machine at twenty inches per minute.

In some embodiments, continuous strand mats of the present invention can be prepared without the use of a binder. The term “binder”, as used herein, will generally refer to a chemical resin in liquid or powder form, that bonds individual fiber glass strands in a mat structure upon heating. The term “binder”, as used in the present application, does not encompass sizing compositions applied to fiber glass filaments after formation, which are discussed in more detail below.

In some embodiments, continuous strand mats of the present invention are not primarily formed by a binder. The use of binders, in powder or liquid form, may not be desirable for a number of reasons as discussed above. However, some embodiments of the present invention may also include some binder. In these embodiments, while some binder may be used, the binder is not the principle way in which the strands are secured or otherwise held in position.

The stitch bonding of the continuous strands can provide a number of advantages over primarily forming a mat using a binder. For example, stitch bonding can provide a significant level of mechanical integrity to the mat without the costs associated with binders, without the stiffness associated with binders, without the undesirable color effects of binders, and without other disadvantages commonly associated with the use of binders. While embodiments of mats may be primarily formed by stitch bonding, mechanical integrity may also be realized from other sources in accordance with further embodiments of the present invention. For example, in some embodiments, the laid down continuous strands may be needled prior to stitch bonding as set forth below.

In some embodiments, a loose mat of continuous strands can be stitch bonded immediately after the strands are laid down without a need to transport the loose mat to a stitch bonding machine other than by a conveyor between the lay down machine and the stitch bonding machine. As used herein, the term “loose mat” refers to a plurality of continuous strands that are not secured to one another or not otherwise held in position, such that the plurality of strands do not have enough mechanical integrity to be handled without significantly disturbing the orientation of the strands. A “loose mat” of continuous strands has not been needled, has not been bonded with a binder, and has not been stitch bonded.

Embodiments of the present invention can allow a loose mat of continuous strands to be laid down on a lay down machine and transported to a stitch bonding machine. In order to transport the loose mat to the stitch bonding machine, support can be provided to the loose mat to allow it to be collected (e.g., festooned, folded, packed, rolled, etc.), transported to the stitch bonding machine, and provided to the stitch bonding machine. Embodiments of the present invention may utilize needling to provide some mechanical integrity to the loose mat. In embodiments where the loose mat is needled, the needled loose mat can be placed in a container, box, bin, or other storage device for delivery to the stitch bonding machine. The needled loose mat, in some embodiments, can be folded, festooned, or otherwise placed in the storage device. Other embodiments can involve laying down continuous strands on a film, which enable the loose mat of continuous strands to be rolled and delivered to a stitch bonding machine.

In some embodiments, continuous strand mats can comprise a layer comprising a plurality of randomly oriented continuous strands of glass fibers and a plurality of stitches through the layer comprising at least one stitch yarn, wherein the stitches secure at least a portion of the plurality of strands to form the mat. In some embodiments, the mat may be primarily formed by the plurality of stitches securing at least a portion of the plurality of strands. Continuous strand mats, in some embodiments, may be formed entirely without the use of a binder. While embodiments of the present invention may utilize no binder in forming the continuous strand mats, there may be situations where some binder is desirable in addition to the stitch bonding of the mat. In these embodiments, some binder may be included in the mat in addition to the stitch yarns, but the mat may not be primarily formed by a binder.

In some embodiments, continuous strand mats of the present invention comprise a layer comprising a plurality of randomly oriented continuous strands of glass fibers and a plurality of stitches securing at least a portion of the plurality of strands, wherein the plurality of stitches comprise at least one stitch yarn, wherein the mat is formed without a binder.

In some embodiments, continuous strand mats of the present invention can have a density of at least 0.5 ounces per square foot. The mat, in other embodiments, can have a density up to about 10 ounces per square foot.

The plurality of stitches, in some embodiments, can be oriented in one or more rows generally parallel to a length of the mat (i.e., generally in the machine direction). The one or more rows, in further embodiments, can be spaced approximately equidistantly across a width of the mat. The one or more rows, in some embodiments, can comprise about seven rows of stitches per two inches of mat width. In some embodiments, the stitch yarns may be spaced, such that there are up to 22 evenly spaced stitch yarns per inch. The spacing of the stitch yarns across the width of the mat is discussed in greater detail below. The selection of a spacing distance may depend on the end application for the stitch bonded mat.

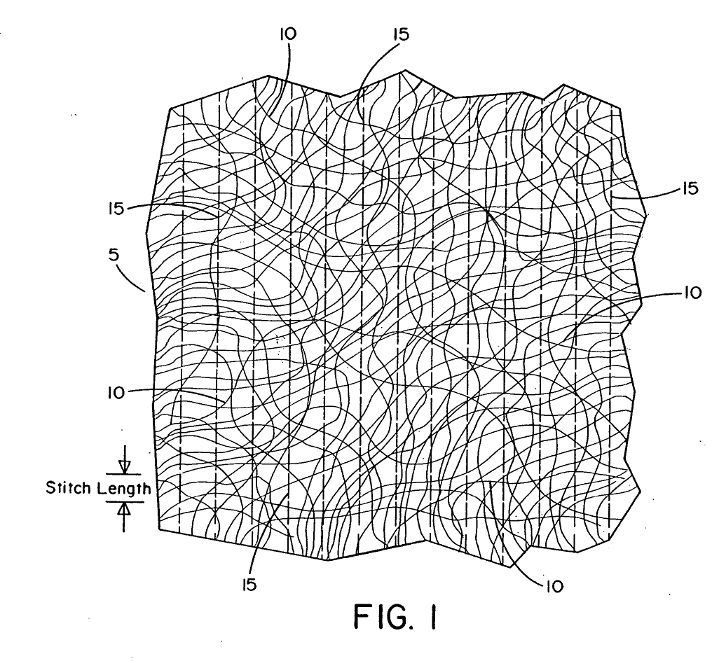

Embodiments of continuous mats may comprise stitch yarns sewn with a variety of stitch lengths. The length of the stitch refers to the distance between needle penetrations on the mat and is illustrated graphically in FIG. 1. One of the factors in selecting a stitch length is the effect on operation and/or operating speed of the stitch bonding machine. For example, if the stitch length is too long, the stitch bonding machine may experience an increase in the number of broken needles. Accordingly, in selecting a stitch length, performance of the stitch bonding machine should be considered in addition to other factors, such as the ability to produce a stitch bonded mat having desirable properties. The stitch length, in embodiments of the present invention may be at least about 0.5 millimeters. In a further embodiment, the stitch lengths may up to about 5 millimeters. In other embodiments, the stitch length may be between about 0.5 millimeters and about 5 millimeters. Stitch length may also be expressed in terms of the number of stitches per inch. The stitch length, in some embodiments, may be greater than about three stitches per inch. In some embodiments, the stitch length may be up to about fifty stitches per inch. The stitch length, in some embodiments, may be up to about ten stitches per inch. The stitch length, in some embodiments, may be between about three and about fifty stitches per inch.

A number of types of stitches and stitch patterns can be used to stitch bond the strands. Examples of stitches that may be utilized in embodiments of the present invention include chain stitches and tricot stitches.

FIG. 1 is a top elevational view of a swatch of an embodiment of a stitch bonded mat 5 of the present invention. The continuous fiber glass strands 10 shown in FIG. 1 are for illustrative purposes and should not be construed as an example of the density of the mat 5, the size of the fiber glass strands 10, and the relative size of the fiber glass strands 10 to the stitch yarns 15. In the embodiment shown, a plurality of stitch yarns 15 were chain stitched in the machine direction of the mat 5.

In other embodiments, another mat, such as a veil mat, may be attached to a first side of a continuous strand mat of the present invention. In a further embodiment, a second veil mat may be attached to a second side of the continuous strand mat.

In other embodiments, a continuous strand mat of the present invention may also comprise a plurality of rovings attached to the mat. In some embodiments, at least a portion of the plurality of rovings may comprise unidirectional rovings generally oriented in the machine direction of the mat. In another embodiment, a plurality of unidirectional rovings may be attached proximate a first longitudinal edge of the mat. A plurality of unidirectional rovings, in another embodiment, may be attached proximate a second longitudinal edge of the mat. In a further embodiment, the plurality of unidirectional rovings are stitch bonded to the mat. The term “roving” as used herein means at least one strand or, if a plurality of strands are used, a plurality of strands grouped together. As used herein, the term “unidirectional” means that the fibers, yarns or strands are generally oriented in the same direction.

In other embodiments, a continuous strand mat of the present invention comprises fiber glass and at least one non-glass fiber. The at least one non-glass fiber may comprise textile filaments, yarns or the like of natural, man-made or synthetic materials. Non-limiting examples of such natural fibers can include cotton fibers; man-made fibers include cellulosic fibers such as rayon and graphite (carbon) fibers; and synthetic fibers including polyester fibers, polyolefin fibers such as polyethylene or polypropylene, and polyamide fibers such as nylon and aromatic polyamide fibers (an example of which is Kevlar™, which is commercially available from E. I. Dupont de Nemours Co. of Wilmington, Del.). The at least one non-glass fiber can be a continuous fiber or a continuous strand of fibers that is supplied from a package. For example, the non-glass fiber can be supplied to strand feeders from a package or plurality of packages in a manner that is similar to the way fiber glass strands are supplied to the strand feeders. In one embodiment, the continuous strand mat comprises at least 50% fiber glass. In a further embodiment, the at least one non-glass fiber comprises polyester.

Other embodiments of the present invention relate to methods of producing continuous strand mats. Embodiments of a method of the present invention may comprise forming a loose mat of continuous strands of fiber glass and stitch bonding the loose mat. A further embodiment of a method of the present invention may comprise needling the continuous strands so as to entangle individual glass strands together with one another. Other embodiments of methods of the present invention will be discussed in more detail below.

Other embodiments of the present invention relate to system for producing continuous strand mats. In one embodiment, a system of the present invention comprises a supply of fiber glass strands, a lay down machine for a randomly oriented continuous strand mat, and a stitch bonding machine. In a further embodiment, the system may comprise a needling device. Other embodiments of system of the present invention will be discussed in more detail below.

Glass fibers useful in embodiments of the present invention can be formed using any suitable method known in the art for forming glass fibers. For example, glass fibers can be formed in a direct-melt fiber forming operation or in an indirect, or marble-melt, fiber forming operation. In a direct-melt fiber forming operation, raw materials are combined, melted and homogenized in a glass melting furnace. The molten glass moves from the furnace to a forehearth and into fiber forming apparatuses, such as bushings, where the molten glass is attenuated into continuous glass fibers. In a marble-melt glass forming operation, pieces or marbles of glass having the final desired glass composition are preformed and fed into a bushing where they are melted and attenuated into continuous glass fibers. If a premelter is used, the marbles are fed first into the premelter, melted, and then the melted glass is fed into a fiber forming apparatus, such as a bushing where the glass is attenuated to form continuous fibers. In the present invention, the glass fibers can be formed by the direct-melt fiber forming operation. For additional information relating to glass compositions and methods of forming the glass fibers, see K. Lowenstein, The Manufacturing Technology of Continuous Glass Fibres, (3d Ed. 1993), at pages 30-44, 47-103, and 115-165, which are specifically incorporated by reference herein.

After the fibers have cooled very shortly after their issuance from a bushing and usually in close proximity to the bushing, the fibers are at least partially coated with a sizing composition. The sizing composition can be applied by sprayers, rollers, belts, metering devices, or other similar application devices. While the sizing compositions are sometimes referred to as binders, the use of the term binder herein should not be understood to include sizing compositions. The sized glass fibers are gathered into strands comprising a plurality of individual fibers, generally from 80 to more than 4000.

After their formation and treatment, the strands are sometimes wound into a “forming package.” A strand can be wound onto a paper or plastic tube using a winder. The forming packages are usually dried in either an oven or at room temperature to remove some or all of the moisture from the fibers. After drying, the paper or plastic tubes can be removed from the forming packages to allow inside payout of the forming packages. For example, the forming packages may be positioned on a creel in a horizontal position. The paper or plastic tubes may be collapsed and pulled out from the forming packages. An operator may then identify an end on the interior of the forming package that can be fed to mat lay down machine or other device. Additional information related to fiberizable glass compositions and methods of making glass filaments are disclosed in K. Lowenstein, The Manufacturing Technology of Glass Fibres, (3d Ed. 1993) at pages 30-44, 47-60, 115-122 and 126-135, which is hereby incorporated by reference.

In some embodiments, the fiber glass strands can be supplied directly to a lay down machine without winding the strand into a forming package.

Glass fibers used to form strands for making continuous strand mats of the present invention can have a nominal filament diameter ranging from about 5 to about 35 micrometers (corresponding to a filament designation of D through U and above), and preferably have a nominal filament diameter ranging from about 11 to about 23 micrometers. Although the number of filaments may be selected based on the desired application, the number of filaments per strand for making continuous strand mats in some embodiments of the present invention can range up to 1,000 filaments per strand. In other embodiments, the number of filaments per strand can range up to 800 filaments per strand. In other embodiments, the number of filaments per strand can be between forty and 800 filaments per strand. As an example, a strand useful in some embodiments can comprise eighty filaments per strand.

In general, any fiber glass product that is currently used in continuous glass reinforcement applications may be used to form the continuous strand mats of the present invention. Certain ranges of filament diameters and number of filaments per strand may be of particular interest due to customer requirements, end uses of the mats, and other factors. For example and without limitation, fiber glass strands useful in forming continuous strand mats may have about eighty filaments per strand, each filament having a diameter of about 11 microns. Embodiments of the present invention using strands that comprise up to about 800 filaments per strand, each strand having a diameter between about 11 and about 23 microns may be of particular interest for continuous strand mat applications.

In one non-limiting embodiment, a glass strand to be used in a continuous strand mat of the present invention comprises eighty filaments of eleven micron diameter E-glass fibers treated with a sizing that is chemically compatible with the resin system which the mat will reinforce.

Fiber glass strands useful to form mats of the present invention may be at least partially coated with a variety of sizing compositions known to those of skill in the art. In particular, sizing compositions that are known to those of ordinary skill in the art to be useful in coating fiber glass stands for use in continuous strand mats are acceptable. The chemical characteristics of sizing compositions useful in embodiments of the present invention are such that they are compatible with the intended end-use of the fibers. For example, when the material to be reinforced is a thermoset resin, the sizing composition will normally include a compatible thermosetting resin. Thus, the selection of a sizing composition will also depend on the resin that the mat will reinforce. Examples of such sizing compositions include those that are used to coat strands for use in continuous strand mats and that are compatible with a number of thermoset resins, including polyester, vinyl ester, phenolic, and epoxy resins.

To prepare a continuous strand mat of the present invention, a plurality of forming packages is supplied to a fiber lay down machine. In one embodiment, the plurality of forming packages is placed in a creel to allow for inside payout of the strands. While inside payout of the forming packages is conventional, the forming packages, in other embodiments, may be paid out from the outside. Alternatively, in some embodiments, the strands may be fed directly to the fiber lay down machine without winding.

Examples of fiber lay down machines and the operation thereof useful in embodiments of the present invention are set forth in U.S. Pat. No. 3,915,681 (Ackley) and U.S. Pat. No. 4,340,406 (Neubauer, et al.) as well as U.S. Pat. No. 4,963,176 (Bailey, et al.), U.S. Pat. No. 4,964,891 (Schaefer), and U.S. Pat. No. 5,051,122 (Reese, et al.), which are hereby incorporated by reference.

A lay down machine may include a plurality of reciprocating strand feeders which provide the pulling force necessary to advance strands from the supply source and eventually deposit the strands upon the surface of a moving conveyor on the lay down machine. In a typical production environment, as many as twelve to seventeen such strand feeders have been used simultaneously with one another to produce a glass fiber mat. In one non-limiting embodiment, the lay down machine utilizes thirteen strand feeders.

A plurality of strands may be continuously fed into a single strand feeder. The number of strands supplied to each strand feeder depends on the desired density of the continuous strand mat and on the number of strand feeders on the lay down machine. Typically, between four and sixteen strands may be fed to a strand feeder. When forming packages having inside payout are used, the end of one strand in a forming package may be tied or otherwise attached to the beginning of a strand in the next forming package, such that the strands may be fed to the lay down machine somewhat continuously. As noted above, the strand feeders deposit the continuous strands on a moving conveyor to form a loose mat of continuous strands. The speed of the moving conveyor of the lay down machine may also be referred to as the “line speed.” The line speed can be a variety of speeds and may be selected based on machine limitations, ability to produce a uniform weight mat, number of strands fed to lay down machine, and other factors. In one non-limiting embodiment, the line speed of the lay down machine can be ten to forty feet per minute. In a further non-limiting embodiment, the conveyor may move at a speed of twenty-eight feet per minute.

As noted above, depending upon the density of mat to be produced, a number of strands are continuously fed into a plurality of feeders that transverse across moving conveyor chain resulting in a consistent density, yet randomly orientated pattern of strands. For example, to produce a mat that weighs approximately one ounce per square foot, eight strands may be fed to a strand feeder traversing the width of the conveyor with the conveyor moving at a line speed of twenty-eight feet per minute.

The strand feeders position the plurality of strands in a random pattern of loose glass strands on the conveyor of the lay down machine to form a loose mat. After being laid down, the strands are in a loose, random arrangement. In this form, the loose, randomly oriented strands typically do not have enough mechanical integrity to be subsequently handled as a mat and to be eventually fabricated into a finished laminate.

In one embodiment, the loose, randomly oriented strands, or loose mat, arranged on the lay down machine may be fed directly to a stitch bonding machine. For example, the loose mat of continuous strands may be transferred from the conveyor of a lay down machine directly to the conveyor of a stitch bonding machine. Thus, in some embodiments, a stitch bonding machine may be positioned at or near a lay down machine such that the loose mat of continuous strands may be transported by conveyor or similar mechanism directly from the lay down machine to the stitch bonding machine without having to gather, fold, festoon, roll, or otherwise collect the loose, randomly oriented strands.

From a technical design perspective, direct transfer from a lay down machine to a stitch bonding machine might be preferable as the inclusion of other manufacturing techniques to support the mat or provide mechanical integrity could introduce additional complications. However, from a commercial manufacturing perspective, direct transfer from a lay down machine to a stitch bonding machine may not be economically efficient. For example, stitch-bonding machines may operate at a slower line speed or throughput than lay down machines. Thus, a manufacturer may have to slow the line speed of the lay down machine to accommodate the speed of the stitch bonding machine, which can introduce inefficiencies to the process. As stitch bonding technology evolves and as line speeds increase, the differences in line speeds between lay down machines and stitch bonding machines may decrease such that direct transfer from the lay down machine to the stitch bonding machine can become more economically efficient.

Difficulties in direct transfer from a lay down machine to a stitch bonding machine might also arise if the stitch bonding machine breaks down and needs repair as it might be undesirable to stop laying down loose mats while waiting for the stitch-binding machine to be prepared. Accordingly, while direct transfer from a mat lay down machine to a stitch bonding machine is a desirable embodiment of the present invention, in other embodiments, the loose mat of continuous strands is not transferred directly from the lay down machine to the stitch bonding machine.

Due to the looseness of the strands upon leaving the lay down machine as set forth above, the structure of the randomly oriented strands needs to be preserved until the strands can be stitch bonded. In one embodiment of the present invention, the loose mat of continuous strands leaving the lay down machine may be lightly needled so as to entangle the individual glass strands together with one another. This needling may only need to be sufficient to hold the strands in place for subsequent stitch bonding. Needling the strands can help preserve orientation of the strands during transport to a stitch bonding machine. In one embodiment, the loose mat of continuous strands can be needled by passing them through a needling device wherein a plurality of barbed needles are reciprocated up and down so as to penetrate the strands and thereby entangle them with one another. This technique is further described in U.S. Pat. No. 3,713,962 (Ackley), U.S. Pat. No. 4,277,531 (Picone), U.S. Pat. No. 4,404,717 (Neubauer, et al.), and U.S. Pat. No. 4,964,891 (Schaefer), which are hereby incorporated by reference.

An example of a commercially available needling device suitable for use with embodiments of the present invention is a Model NL-9 single sided needling device, commercially available from Fehrer AG. In some embodiments, the loose mat of continuous strands are needled from the underside of the random strands. In other embodiments, the loose mat of continuous strands are needled from the top side. In some embodiments, the loose mat of continuous strands are needled from both sides. The needles, in some embodiments, may be 19 to 48 gauge needles. In a further embodiment, the loose mat of continuous strands are needled using 25 gauge needles. In one embodiment, the needles penetrate from about 0.4 inches to about 1.0 inches into the layers of random strands. In a further embodiment, the needles penetrate the random continuous strands at a rate of about 40 to about 200 penetrations per square inch. The loft of the needled mat can be controlled by mechanical fingers at the entrance of the needling device. In some embodiments, the needled mat can have a loft greater than about 0.1 inch. In other embodiments, the needled mat can have a loft up to about two inches. The needled mat, in other embodiments, can have a loft up to about 1 inch. In other embodiments, the needled mat can have a loft up to about 0.75 inches.

The needling described above can be characterized as “lighter” than needling that would be performed if the needling were to be the sole means of providing mechanical integrity. In accordance with embodiments of the present invention, heavy needling may need to be avoided due to the increased number of broken filaments that may result. The needling necessary in embodiments of the present invention utilizing a stitch bonding machine need only be sufficient to hold the strands in place for subsequent stitch bonding. As noted above, needling the strands can help preserve orientation of the strands during transport to a stitch bonding machine.

The needling device can be adjacent to the lay down machine in some embodiments, such that the loose mat of continuous strands can be lightly needled after the strands are laid down. By lightly needling the strands soon after they are laid down, the random orientation of the strands is maintained as well as the desired uniformity of the density of the mat. Needling devices, including those mentioned above, have been designed to be positioned adjacent to lay down machines and to operate at the same line speed.

In other embodiments, including embodiments that do not include needling, the loose mat of randomly oriented continuous strands may be placed on a film and rolled for transport to a stitch bonding machine. The film may assist in supporting the weight of the strands and help maintain their orientation and density during roll take up, during transport, and during unrolling at the stitch bonding machine.

The mat, either after needling or after being laid down on a film with/without needling, may then be transported to a stitch bonding machine. The mat may be transported in a number of ways to a stitch bonding machine. As set forth above, it is important to maintain the random orientation of the strands in the mat and to maintain the density of the mat during transport. For example, it would be undesirable for strands to concentrate in a particular portion due to the manner in which the mat was transported. Factors that can affect the way in which the laid down mat is transferred can include, without limitation, the mechanical integrity of the mat, the distance between the lay down machine (or lay down machine and needler) and the stitch bonding machine, whether the continuous strands were laid down on a film, the size and length of laid down mat, and others.

In some embodiments of the present invention, a needled mat may be folded, festooned, or otherwise placed into a container or similar bin to be transported to a stitch bonding machine. Such embodiments may be useful if there is substantial distance between the needling device and the stitch bonding machine (e.g., if the machines are in different areas of a building, in different buildings, in different cities, etc.). If the needled mat is able to maintain its structure and to support its own weight, then the needled mat can be loaded and delivered in this manner rather than use a film or other structure to support the mat.

The needled mat can be folded into such containers, in some embodiments, as the mat reaches the end of a conveyor leading out of the needling device. The needled mat can be repeatedly folded on itself as it enters the container. The container can be constructed from any number of materials known to those of skill in the art including, without limitation, plastic, cardboard, and other materials. The container can be covered with a lid, shrunk wrap, taped, and/or otherwise closed to protect the needled mat in some embodiments, while in other embodiments, the container can remain open.

In other embodiments, a needled mat may be wound on a paper tube for delivery to a stitch bonding machine. In these embodiments, the needling step also introduces enough strength to the mat for it to maintain its structure during winding on the paper tube, during transport to the stitch bonding machine, and during unwinding of the paper tube to feed the stitch bonding machine.

In other embodiments, a film may be placed under the needled mat and the needled mat may be wound on a paper tube or placed in a container for delivery to the stitch bonding machine. In these embodiments, the film is removed as the needled mat is fed to the stitch bonding machine. In one embodiment, the film may be a polyester film.

In one embodiment and as an alternative to needling, the strands could be randomly oriented on a polyester film during the lay down step. In other words, a polyester film may be supplied to the lay down machine and the strand feeders may position the strands on the polyester film. At the end of the lay down machine, the strands and the polyester film may be wound into a roll to preserve the orientation of the strands. The roll may be transported to a stitch bonding machine and unwound with the randomly oriented strands being fed to the stitch bonding machine.

Embodiments of the present invention thus can advantageously allow for the transport of a laid down mat of continuous strands, with or without needling, to be transported to a stitch bonding machine. Embodiments of the present invention can advantageously provide sufficient support for a laid down mat of continuous strand mats to be transported and delivered to a stitch bonding machine while maintaining the desired density and weight uniformity of the laid down mat.

At the stitch bonding machine, a stitch yarn is passed through the loose mat to hold the strands in place during delivery to a customer and during impregnation with a resin. Although the terms “yarn” and “stitch yarn” are used throughout this specification, it should be understood that in some embodiments of the present invention, a monofilament or single thread can be used to stitch mats. In selecting a stitch, it can be important for the stitch selected to be secure and to help avoid unraveling of the stitch yarn from the mat. Depending on the stitch type selected, the stitch yarn can pass upwardly and downwardly through the mat, form loops, and pass back through the loops to form stitches in the mat.

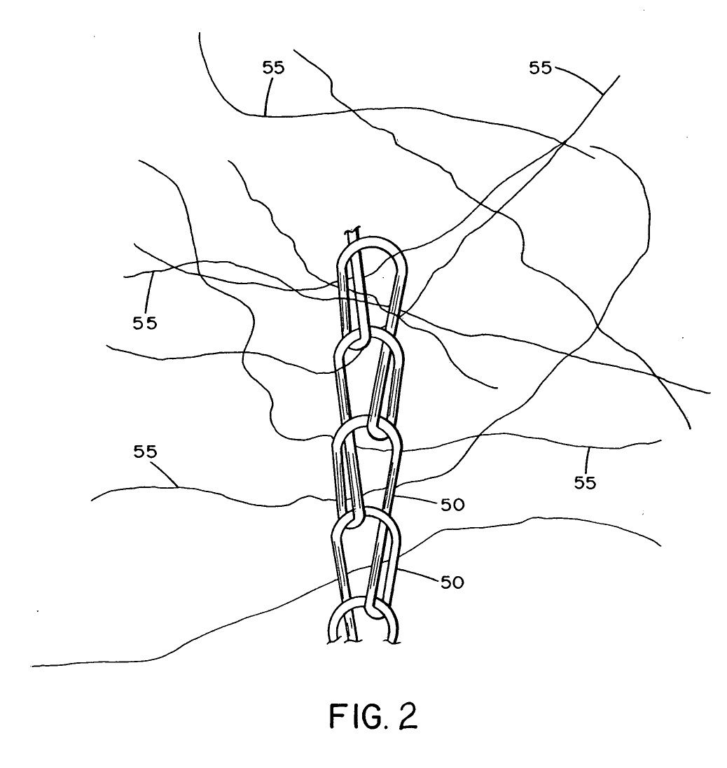

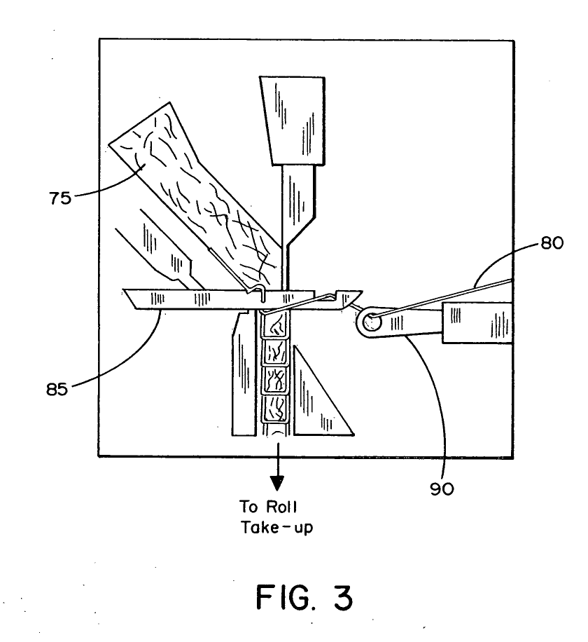

FIG. 2 illustrates an example of a chain stitch that may be utilized in embodiments of the present invention. The stitch selected can loop back through itself to secure the stitch and to help prevent the stitch yarn 50 from unraveling. The continuous fiber glass strands 55 and the stitch yarn 50 shown in FIG. 2 are for illustrative purposes and should not be construed as an example of the density of the mat, the size of the fiber glass strands, and the relative size of the fiber glass strands to the stitch yarns. FIG. 3 is an example of a mechanical technique that can be used to stitch bond continuous strand mats of the present invention. The stitching components shown in FIG. 3 are those that may be found in a Maliwatt stitch bonding machine, commercially available from Karl Mayer Textilmaschinenfabrik GmbH. In the embodiment shown, continuous fiber glass strand 75 is stitched with a stitch yarn 80 using a piercing needle 85 and a guide needle 90.

The stitch yarns can run parallel to the length of the mat in the machine direction in some embodiments. A plurality of stitch yarns may stitch bond the continuous strands. The stitch yarns can be spaced apart from one another to sufficiently hold the continuous strands in place. Factors in determining the spacing of the stitch yarn include cost, ability to hold the strands in place, and the ability of mat to wet out with resin at a desirable rate. In one embodiment, the stitch yarns are evenly spaced across the width of the mat. In one embodiment, the stitch yarns may be spaced, such that there are up to 22 evenly spaced stitch yarns per inch. The stitch yarns, in one embodiment, may be spaced such that there are seven stitch yarns per two inches of mat width. The spacing of the stitch yarns may be selected based on the contemplated end use of the mat. In embodiments where the mat needs to be more flexible, a greater distance between stitch yarns may be selected. In other embodiments where mat flexibility may not be a concern, it may be desirable to space the stitch yarns at a smaller distance. For mats to be used in pultrusion applications, for example, the stitch yarns may be spaced at a distance such that there are seven approximately equidistant gaps between the stitch yarns over two inches (three and a half gauge).

An example a of stitch bonding machine useful in the present invention is a Maliwatt stitch bonding machine manufactured by Karl Mayer Textilmaschinenfabrik GmbH of Chemnitz, Germany. Another example of a stitch-bonding useful in the present invention is a Copcentra Max 3 CNC stitch-bonding machine manufactured by Liba Maschinenfabrik GmbH of Naila; Germany. The width of the stitch bonding machine, in one embodiment, may be between about 55 inches and 180 inches.

The mat may be fed to the stitch bonding machine using a number of techniques. For example, if the mat is transported to the stitch bonding machine in a container, the mat may be conveyed via a belt from the container to the stitch bonding machine.

The stitch bonding machine stitch bonds the strands together. Examples of textile products that can be used as stitch yarns include polyester yarns, textured polyester yarns, textured and untextured polypropylene yarns, textured and untextured nylon yarns, fiber glass, KEVLAR (polyaromatic amide), carbon, and textured fiber glass.

In some embodiments, polyester yarns are used as stitch yarns. Polyester may be desirable as a stitch yarn because its elongation and abrasion resistance make it better able to withstand the pathway from its supply through the stitch bonding machine. In one non-limiting embodiment, the stitch yarn may be 70 to 150 denier textured or filament polyester yarn fed from beams or packages. Examples of suitable polyester yarns for use as stitch yarns in the present invention include 70 denier textured polyester yarns and 150 denier textured yarns, such as those commercially available from Unifi, Inc.

Fiber glass may be an attractive alternative to polyester stitch yarns. For example, polyester yarns are not believed to provide reinforcement to a thermosetting polymer as the elongations of polyester yarns are typically longer than the elongations of the thermosetting polymer. In contrast, a fiber glass stitch yarn is expected to wet out well and can provide some additional reinforcement to the composite. A fiber glass stitch yarn can preferably withstand the processing conditions necessary to supply the fiber glass stitch yarn to the stitch bonding machine.

In some embodiments, the stitch yarns comprise greater than about 0.03 percent by weight of the stitch bonded continuous strand mat. In one embodiment, the stitch yarns comprise up to eight percent by weight of the stitch bonded continuous strand mat. In other embodiments, the stitch yarns may comprise up to five percent by weight. In another embodiment, the stitch yarns may comprise up to two percent by weight. In another embodiment, the stitch yarns may comprise up to 0.3 percent by weight.

In one non-limiting embodiment, the strands are stitch bonded together at a line speed of about five to about twenty linear feet per minute. In these embodiments, the needle wheels in the stitch bonding machine may be rotating at a rate of between 800 and 1400 revolutions per minute, although other rotating speeds may be used depending on the machine, the material to be stitch bonded, and other factors. A variety of needles could be used to stitch bond the strands. In selecting needles for use in a stitch bonding machine of the present invention, important factors include potential for large needles to undesirably put holes in the mat and the propensity of small needles to break. Needles useful in embodiments of the present invention may generally be characterized as lightweight needles, mediumweight needles, and heavyweight needles. The heavyweight needles may be better suited for heavier, more dense products due to their size, whereas lightweight needles may be better suited for thin, lighter products. In embodiments of the present invention related to the stitch bonding of continuous strand fiber glass mats, mediumweight needles may be used.

As noted above, a number of stitch lengths and stitch patterns could be used to stitch bond the strands. Factors that are used in selecting stitch patterns and stitch lengths include, for example, the cost of the yarn, the desired tightness of the mat, and the throughput of the stitch bonding machine. The stitch length, in embodiments of the present invention may be at least about 0.5 millimeters. In a further embodiment, the stitch lengths may up to about 5 millimeters. In other embodiments, the stitch length may be between about 0.5 millimeters and about 5 millimeters. Stitch length may also be expressed in terms of the number of stitches per inch. The stitch length, in some embodiments, may be greater than about three stitches per inch. In some embodiments, the stitch length may be up to about fifty stitches per inch. The stitch length, in some embodiments, may be up to about ten stitches per inch. The stitch length, in some embodiments, may be between about three and about fifty stitches per inch.

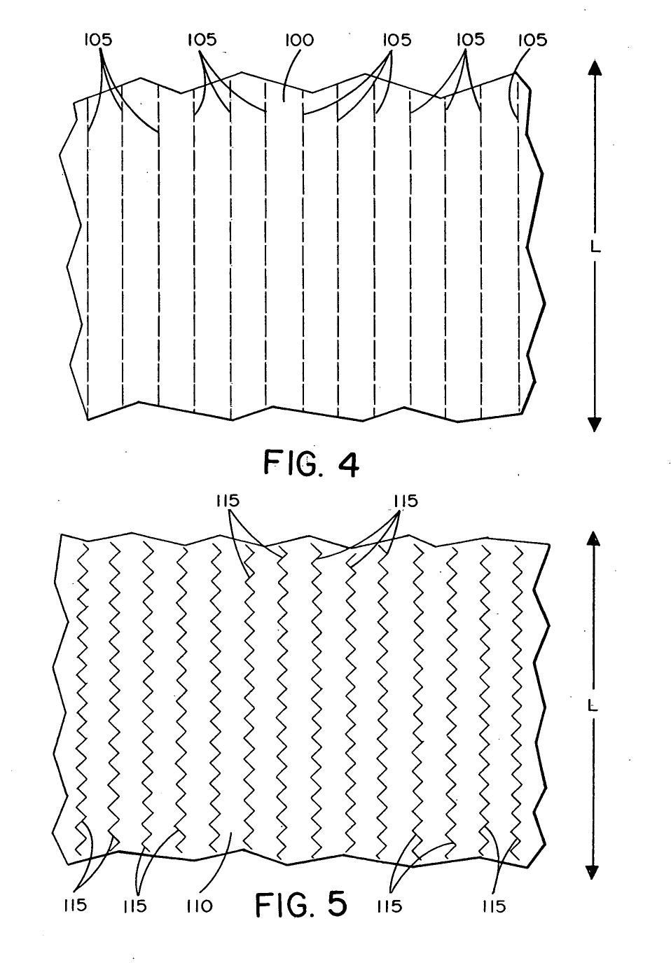

The stitch pattern may be, for example, a chain pattern or a tricot pattern, or both. FIG. 4 is a top elevational view illustrating an embodiment of how stitch yarns 105 may be used to stitch bond a continuous strand mat 100. In the embodiment shown, the yarns 105 are stitched using a plurality of chain stitches. The plurality of stitches are oriented in one or more rows generally parallel to a length (L) of the mat. As only a swatch is shown in FIG. 4, the full length (L) and width of the mat are not shown. Also, the continuous strands are not shown in FIG. 4 to better illustrate the stitching technique.

FIG. 5 is a top elevational view illustrating an embodiment of how stitch yarns 115 may be used to stitch bond a continuous strand mat 110. In the embodiment shown, the yarns 115 are stitched using a plurality of tricot stitches. The plurality of stitches are oriented in one or more rows generally parallel to a length (L) of the mat. As only a swatch is shown in FIG. 5, the full length (L) and width of the mat are not shown. Also, the continuous strands are not shown in FIG. 5 to better illustrate the stitching technique.

In supplying a needled mat to a stitch bonding machine in accordance with embodiments of the present invention, it can be important for the needled mat to be fed to the machine at the same speed as the line speed of the stitch bonding machine. For example, if the needled mat is being unwound from a cardboard roll, then the mat is preferably unwound at the same speed as the mat will be passed through the stitch bonding machine. It can also be important to operate within a range of line speeds and needling speeds (e.g., revolutions of the needling wheel per minute) so as to avoid breaking needles and to avoid broken filaments in the mat. It can also be important to insure that the needled mat is supplied to the stitch bonding machine with no wrinkles or folds.

After stitch bonding, the resulting material is considered a continuous strand mat and is suitable for use in reinforcement application.

Without stitch bonding, the strands would separate in customers' pultrusion, compression molding, resin transfer molding, or vacuum assist resin transfer molding operations. Upon exit from the stitch bonding machine, the mat can be wound on cardboard tube using a conventional surface wind take up device.

In further embodiment, the continuous strand mats can be slit to specific widths depending on a customer's requirements or depending on the desired use. For example, continuous strand mats of the present invention can be slit to specific widths immediately after stitch bonding, and prior to take up, by using rotating, blade knives. In other embodiments, the mats are not slit by the mat manufacturer, but may be slit by the manufacturers' customers. In one embodiment, a continuous strand mat may be slit into a plurality of sections having widths of two inches or greater. Examples of widths to which stitch bonded mats may be slit include, without limitation, a variety of widths between two and twenty-four inches, thirty-eight inches, fifty inches, sixty inches, seventy-two inches, and others depending on the customer's requirements or desired use. When continuous strand mats are slit, some of the strands near the edge of the mat may be cut, such that the lengths of the strands in the slit mat may be shorter than the lengths of the strands when laid down and stitch bonded.

The stitch bonded continuous strand mats of the present invention can have a density between about 0.5 ounces per square foot and about 10 ounces per square foot. In another embodiment, stitch bonded continuous strand mat can have a density between about 0.75 ounces per square foot and about three ounces per square foot. The density of the mat may be selected based on the desired end product (e.g., the composite material to be formed). The stitch bonded continuous strand mats may also have a uniform density, which is advantageous as a mat with a uniform density mat will contribute to a composite with more uniform strength.

Stitch bonded continuous strand mats of the present invention may be used in a number of applications to produce a composite, including, for example, pultrusion, compression molding, resin transfer molding, structural reaction injection molding, or vacuum assist resin transfer molding operations. In general, the stitch bonded continuous strand mats of the present invention can be used in any application in which continuous strand mats have been used in the past. Further, the stitch bonded continuous strand mats may be compatible with any number of thermoplastic or thermoset resins, an appropriate sizing composition being selected (e.g., a sizing composition compatible with the resin) in a manner known to those of ordinary skill in the art. The stitch bonded continuous strand mats of the present invention may also be useful in other applications where continuous strand mats have not traditionally been used. For example, the present invention can provide very light density mats with adequate tensile strength for processing as well as heavier density mats that are soft and flexible.

In some embodiments, another mat may be attached to one side of a continuous strand mat. In one embodiment, the mat may be a synthetic mat, such as a fiber glass mat or a polyester mat. In some embodiments, the mat may be a synthetic, nonwoven mat, such as a nonwoven fiber glass mat or a nonwoven polyester mat. In some embodiments, at least one veil mat may be attached to a continuous strand mat. A veil mat may be used with a continuous strand mat to provide properties to the mat that a fiber glass continuous strand mat alone may not provide. For example, a veil mat may be used to provide a smooth, resin-rich composite surface. The veil mat may also provide improved weather resistance and ultraviolet resistance. Veil mats useful in the present invention include nonwoven mats constructed from polyester. Commercially available veil mats that may be used with continuous strand mats of the present invention include NEXUS® brand veil mats commercially available from Precision Fabrics Group, Inc. and REEMAY® brand veil mats commercially available from Reemay, Inc. of Old Hickory, Tenn.

In an embodiment utilizing a veil mat, the veil mat and the continuous strand mat may be fed to a stitch bonding machine simultaneously. In other words, in addition to supplying a needled continuous strand mat from a needling device to a stitch bonding machine, a veil mat may also be provided such that the needled continuous strand mat is stitch bonded and the veil mat is secured to the continuous strand mat. The veil mat may be positioned above or below the continuous strand mat in the stitch bonding machine. The veil mat may be stitch bonded to the continuous strand mat in the same manner in which a continuous strand mat may be stitch bonded alone as set forth above. In addition to securing the veil mat to the continuous strands, the stitch bonding machine also stitch bonds the strands to hold them in position.

In a further embodiment, two or more veil mats may be attached to a continuous strand mat of the present invention. The continuous strand mat may be positioned between the two veil mats. The second veil mat may be any of the veil mats described above. Both veil mats may be secured to the continuous strand mat as described above by supplying both veil mats and the needled continuous strands to the stitch bonding machine.

In other embodiments, a continuous strand mat of the present invention may further comprise a plurality of rovings attached to the mat. The term “roving” as used herein means at least one strand or, if a plurality of strands are used, a plurality of strands grouped together. The rovings may be supplied to provide additional structural support to the mat and to provide additional reinforcement of the composite. Examples of materials that can be used as rovings include fiber glass, carbon fiber, and/or KEVLAR® fiber.

In some embodiments, the plurality of rovings may comprise a plurality of unidirectional rovings. As used herein, the term “unidirectional” means that the fibers, yarns or strands are generally oriented in the same direction. In some embodiments, each roving may be oriented generally parallel to a length of the mat, or generally oriented in the machine direction of the stitch bonding machine. In some embodiments, the plurality of rovings may be spaced approximately equidistantly across a width of the mat.

At least a portion of the plurality of rovings, in some embodiments, may be oriented generally parallel to a length of the mat. In some embodiments, at least a portion of the plurality of rovings may be oriented generally perpendicular to a length of the mat. In some embodiments, at least a portion of the plurality of rovings may be oriented generally at a forty-five degree angle to a length of the mat.

In some embodiments, at least one roving is provided and fed on the needled mat to the stitch bonding machine (i.e., in the machine direction). In such an embodiment, between 36 and 200 rovings may be supplied to the stitch bonding machine. In general, rovings suitable for use in embodiments of the present invention may have between 2,000 and 5,000 filaments, each filament having a diameter of between 13 and 23 microns, and coated with a sizing composition that may be compatible with a variety of different resins. Examples of rovings suitable for use in the present invention include, for example, are commercially available from PPG Industries, Inc. under the HYBON® product line, including, without limitation, HYBON® 2002, HYBON® 2022, HYBON® 2025, HYBON® 2026, and HYBON® 2032 rovings.

The plurality of unidirectional rovings, in some embodiments, may be stitch bonded at the same time the continuous strands are stitch bonded to form the mat. The rovings may be stitch bonded, in one embodiment, using a tricot stitch pattern. The rovings may be supplied to the stitch bonding machine at the same time the randomly oriented continuous strands from the needling device are supplied. For example, the rovings may be provided as a roving package and fed from creels to the machine as the needled strands are supplied. The rovings may be generally oriented in the machine direction and may be supplied at any location across the width of the continuous strand mat. The stitch yarns, in addition to securing the continuous strands to form the mat, also secure the roving to the mat. In other embodiments, rovings may also be added as continuous strands at the lay down machine prior to needling.

### EXAMPLE 1

For this example, a lab scale machine was used to lay down and needle the continuous strands. The machine utilized a single strand feeder (as is used in larger machines), which traversed across the width of a conveyor to lay down the strands of fiber glass. The lay down machine was fifty inches wide. Eight strands of fiber glass were fed simultaneously to the strand feeder. Each strand included one hundred filaments of eleven microns each and was coated with a sizing composition suitable for use in continuous strand mats and compatible with a thermosetting polyester. The line speed of the conveyor was six feet per minute.

The laid down fiber glass strands were then needled using a needling device connected to the lay down machine. The laid down strands were needled at 160 penetrations per inch at a depth of 0.45 inches using 25 gauge needles. The needled mat was then positioned on a film and rolled.

The needled mat was transported to a stitch bonding machine. The mat was stitch bonded using 150 denier textured polyester yarns. A chain stitch was used with a stitch length of 4.2 millimeters. The line speed of the stitch bonding machine was nine feet per minute and the needle wheels rotated at a speed of 900 rpm.

The stitch bonded mat was cut to a width of four inches and delivered to a pultrusion device. The pultrusion device used for this example was a Model 804 pultrusion machine manufactured by Pultrusion Technology, Inc. The resin used to form the composite was Reichhold 31020 thermosetting polymer, which was mixed with a calcium carbonate filler, a catalyst system, a pigment, polyvinyl acetate, a lubricant, and styrene to form a resin mixture. The resin mixture was added to a resin bath at the pultrusion device. A plurality of unidirectional rovings were passed through the resin bath and picked up the resin mixture. The rovings were then positioned between two stitch bonded mats (one stitch bonded mat on top and one stitch bonded mat on bottom). The mats were passed through a thermally heated mold, which for this example, was four inches wide and 2.5 millimeters thick. The mats were heated while passing through a series of temperature zones, ranging from 270° F. to 350° F. The mats passed through the pultrusion device at a rate of two feet per minute. The composite was then cooled at room temperature.

Prior to testing of mechanical properties, specimens of the composite were cut and conditioned for at least sixteen hours in the environment of the testing labs. For this example, the mechanical properties of the composite were measured in the transverse direction of the composite (e.g., across the four inch width of the composite). The flexural strength and flexural modulus of the composite was measured using ISO 14125. The average flexural strength was 154 MPa and the average flexural modulus was 9827 MPa. The tensile strength of the composite was measured using a modified version of ISO 527 (modified due to the shorter specimen size). The measured tensile strength was 4.67 ksi (thousand psi). The in-plane shear strength of the composite was measured using ASTM D3846 and was measured to be 7.98 ksi (thousand psi).

### EXAMPLE 2

For this example, a manufacturing machine was used to lay down and needle the continuous strands. The machine utilized a multiple strand feeder (as is used in larger machines). The machine included seventeen strand feeders, which traversed across the width of a conveyor to lay down the strands of fiber glass. Four of the seventeen strand feeders were in reserve until one of the other thirteen strand feeders laying down the strands ran out of fiber glass. When one of the strand feeders was out of fiber glass, one of those four strand feeders would begin laying down strands of fiber glass. The lay down machine was one hundred fourteen inches wide. Seven strands of fiber glass were fed simultaneously to the strand feeder. Each strand included eighty filaments of eleven microns each and was coated with a sizing composition suitable for use in continuous strand mats and compatible with a thermosetting polyester. The line speed of the conveyor was twenty-five feet per minute.

The laid down fiber glass strands were then needled using a needling device connected to the lay down machine. The laid down strands were needled at 60 penetrations per inch at a depth of 0.63 inches using 25 gauge needles. The needled mat was then folded into a container for transportation to a stitch bonding machine.

The needled mat was transported to a stitch bonding machine. The mat was stitch bonded using 70 denier textured polyester yarns. A chain stitch was used with a stitch rate of 6.3 stitches per inch. The line speed of the stitch bonding machine was nine feet per minute and the needle wheels rotated at a speed of 900 rpm.

The stitch bonded mat was cut to a width of eight inches and delivered to a pultrusion device. The pultrusion device used for this example was a Model 804 pultrusion machine manufactured by Pultrusion Technology, Inc. The resin used to form the composite was Ashland AROPOL 3083 thermosetting polymer, which was mixed with a calcium carbonate filler, a catalyst system, a pigment, polyvinyl acetate, a lubricant, and styrene to form a resin mixture. The resin mixture was added to a resin bath at the pultrusion device. A plurality of unidirectional rovings were passed through the resin bath and picked up the resin mixture. The rovings were then positioned between three stitch bonded mats (one stitch bonded mat on top, one stitch bonded mat in the middle, and one stitch bonded mat on bottom). The mats were passed through a thermally heated mold, which for this example, was eight inches wide and 0.125 inches thick. The mats were heated while passing through a series of temperature zones, ranging from 260° F. to 320° F. The mats passed through the pultrusion device at a rate of two feet per minute. The composite was then cooled at room temperature.

Prior to testing of mechanical properties, specimens of the composite were cut and conditioned for at least sixteen hours in the environment of the testing labs. For this example, the mechanical properties of the composite were measured in the transverse direction of the composite (e.g., across the eight inch width of the composite). The flexural strength and flexural modulus of the composite was measured using ISO 14125. The average flexural strength was 177 MPa and the average flexural modulus was 8876 MPa. The tensile strength of the composite was measured using a version of ISO 527. The measured tensile strength was 74 MPa. The compressive strength of the composite was measured using ASTM 695 and was measured to be 17.8 ksi (thousand psi).

Desirable characteristics, which can be exhibited by the present invention, include, but are not limited to, the provision of a process for producing continuous strand fiber glass mats that reduces manufacturing costs; the provision of a process for producing continuous strand fiber glass mats that do not require a binder; the provision of a binderless continuous strand fiber mat having acceptable mechanical properties; the provision of a binderless continuous strand fiber glass mat that can be softer than conventional continuous strand fiber glass mats; the provision of a binderless continuous strand fiber glass mat that can have desirable tensile strength; the provision of a binderless continuous strand fiber glass mat that can have better whiteness than continuous strand mats formed with binders; the provision of a binderless continuous strand fiber glass mat that can have desirable conformability; the provision of continuous strand fiber glass mats that can exhibit desirable resin demand and resin retention resulting in a smooth laminate surface; and the provision of a continuous strand fiber glass mat with few loose fibers.

Various embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the present invention.

1. A continuous strand mat, comprising:
a layer comprising a plurality of randomly oriented continuous strands of glass fibers; and
a plurality of stitches through the layer comprising at least one stitch yarn,
wherein the stitches secure at least a portion of the plurality of strands to form the mat.

2. The mat of claim 1, wherein the mat is primarily formed by the plurality of stitches securing at least a portion of the plurality of strands.

3. The mat of claim 1, wherein the mat is not primarily formed by a binder.

4. The mat of claim 1, wherein the mat is formed without a binder.

5. The mat of claim 1, wherein the mat has a density greater than about 0.5 ounces per square foot.

6. The mat of claim 1, wherein the mat has a density up to about ten ounces per square foot.

7. The mat of claim 1, wherein the plurality of stitches are oriented in one or more rows generally parallel to a length of the mat.

8. The mat of claim 7, wherein the one or more rows are spaced approximately equidistantly across a width of the mat.

9. The mat of claim 1, wherein the plurality of stitches have a stitch length of at least three stitches per inch of mat length.

10. The mat of claim 1, wherein the plurality of stitches have a stitch length up to about fifty stitches per inch of mat length.

11. The mat of claim 1, wherein the stitch yarn comprises polyester yarn.

12. The mat of claim 1, wherein the mat comprises up to about ten weight percent stitch yarn.

13. The mat of claim 1, wherein the mat comprises up to about two weight percent stitch yarn.

14. The mat of claim 1, wherein the mat comprises greater than about 0.03 weight percent stitch yarn.

15. The mat of claim 1, further comprising a second mat attached to a first side of the continuous strand mat.

16. The mat of claim 15, wherein the second mat comprises a veil mat.

17. The mat of claim 16, further comprising a third mat attached to a second side of the mat.

18. The mat of claim 17, wherein the third mat comprises a veil mat.

19. The mat of claim 15, further comprising a third mat attached to a second side of the mat.

20. The mat of claim 1, further comprising a plurality of rovings attached to the mat.

21. The mat of claim 1, wherein the layer further comprises at least one randomly oriented continuous strand of non-glass fiber.

22. The mat of claim 21, wherein the at least one non-glass fiber comprises at least one of cotton fiber, rayon fiber, carbon fiber, polyester fiber, polyethylene fiber, polypropylene fiber, and polyamide fiber.

23. The mat of claim 21, wherein the at least one non-glass fiber comprises polyester.

24. The mat of claim 21, wherein the layer comprises at least 50% fiber glass.

25. A continuous strand mat, comprising:
a layer comprising a plurality of randomly oriented continuous strands of glass fibers; and
a plurality of stitches securing at least a portion of the plurality of strands, wherein the plurality of stitches comprise at least one stitch yarn,
wherein the mat is formed without a binder.

26. A method of producing a continuous strand mat, comprising:
forming a loose mat of continuous strands of fiber glass; and
stitch bonding the loose mat.

27. The method of claim 26, wherein forming a loose mat of continuous strands of fiber glass comprises depositing a plurality of continuous strands of fiber glass on a moving conveyor.

28. The method of claim 27, wherein the plurality of continuous strands are deposited in a random orientation.

29. The method of claim 26, further comprising transferring the loose mat to a stitch bonding machine.

30. The method of claim 29, wherein the continuous strands are in a random orientation.

31. The method of claim 29, wherein the loose mat is transferred on a conveyor.

32. The method of claim 26, further comprising needling the loose mat of continuous strands so as to entangle individual glass strands together with one another.

33. The method of claim 32, wherein the continuous strands are in a random orientation.

34. The method of claim 32, wherein the loose mat is needled from one side.

35. The method of claim 32, wherein the loose mat is needled from both sides.

36. The method of claim 32, further comprising placing the needled loose mat in a container.

37. (canceled)

38. The method of claim 36, further comprising removing the needled loose mat from the container prior to stitch bonding.

39. The method of claim 32, further comprising winding the needled loose mat into a roll.

40. The method of claim 39, further comprising unwinding the needled loose mat from the tube prior to stitch bonding.

41. The method of claim 26, wherein forming a loose mat of continuous strands of fiber glass comprises depositing a plurality of continuous strands of fiber glass on a film.

42. The method of claim 41, wherein the plurality of continuous strands are deposited in a random orientation.

43. The method of claim 41, further comprising winding the loose mat on the film into a roll.

44. The method of claim 43, further comprising unwinding the loose mat on the film and removing the film prior to stitch bonding.

45. The method of claim 26, further comprising cutting the stitch bonded mat into a plurality of mat widths.

46. The method of claim 26, further comprising positioning a second mat proximate a first side of the loose mat of continuous strands, and wherein stitch bonding the loose mat further comprises stitch bonding the second mat to the loose mat.

47. The method of claim 46, further comprising positioning a third mat proximate a second side of the loose mat of continuous strands, and wherein stitch bonding the loose mat further comprises stitch bonding the third mat to the loose mat and the second mat.

48. The method of claim 26, further positioning a plurality of rovings proximate at least one side of the loose mat of continuous strands, and wherein stitch bonding the loose mat further comprises stitch bonding the rovings to the loose mat.

49. A system for producing continuous strand mats, comprising:
a supply of fiber glass strands;
a lay down machine for a randomly oriented continuous strand mat; and
a stitch bonding machine.

50. The system of claim 49, further comprising a needling device.
